(19) United States
(12) Patent Application Publication
(10) Pub. No.: US 2026/0303282 A1
(43) Pub. Date: Oct. 1, 2026

(54) TRIGGERING SOUNDING REFERENCE SIGNALS USING SCHEDULING REQUESTS

(71) Applicant: QUALCOMM Incorporated, San Diego, CA (US)

(72) Inventors: Navid ABEDINI, Basking Ridge, NJ (US); Tao LUO, San Diego, CA (US); Junyi LI, Greentown, PA (US); Jianghong LUO, Skillman, NJ (US); Igor GUTMAN, Hod HaSharon (IL); Sony AKKARAKARAN, Poway, CA (US); Mostafa KHOSHNEVISAN, San Diego, CA (US)

(21) Appl. No.: 19/091,027

(22) Filed: Mar. 26, 2025

(51) Int. Cl. H04L 5/00; H04W 72/21

(52) U.S. Cl. CPC H04L 5/0048; H04W 72/21

(57) ABSTRACT

Various aspects of the present disclosure generally relate to wireless communication. In some aspects, a user equipment (UE) may transmit, in a first set of scheduling request (SR) resources, an SR. The UE may transmit, in a first set of sounding reference signal (SRS) resources that is linked to the first set of SR resources, an SRS. The UE may receive, in response to transmitting the SRS, a grant for transmitting uplink data. Numerous other aspects are described.

### FIELD OF THE DISCLOSURE

Aspects of the present disclosure generally relate to wireless communication and specifically relate to techniques, apparatuses, and methods associated with triggering sounding reference signals using scheduling requests.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In order for a user equipment (UE) to transmit data to a network node in a wireless network (e.g., a 3GPP network), the network node may allocate resources (e.g., in time, frequency, and space) for the UE to use. To improve quality and reliability of the UE's transmission, the network node may measure a reference signal from the UE (usually referred to as a “sounding reference signal” or “SRS”) in order to estimate a channel from the UE to the network node.

### SUMMARY

The systems, methods, and devices of this disclosure each have several innovative aspects, no single one of which is solely responsible for the desirable attributes disclosed herein.

Some aspects described herein relate to a method of wireless communication performed by a user equipment (UE). The method may include transmitting, in a first set of scheduling request (SR) resources, an SR. The method may include transmitting, in a first set of sounding reference signal (SRS) resources that is linked to the first set of SR resources, an SRS. The method may include receiving, in response to transmitting the SRS, a grant for transmitting uplink data.

Some aspects described herein relate to a method of wireless communication performed by a network node. The method may include receiving, in a first set of SR resources, an SR. The method may include performing a measurement, in a first set of SRS resources that is linked to the first set of SR resources, on an SRS. The method may include transmitting, in response to the SRS, a grant, based at least in part on the measurement, for transmitting uplink data.

Some aspects described herein relate to a method of wireless communication performed by a UE. The method may include transmitting, in a first set of SRS resources, an SRS that is associated with a logical channel. The method may include receiving, in response to transmitting the SRS, a grant for transmitting uplink data. The method may include transmitting the uplink data, using the logical channel, according to the grant.

Some aspects described herein relate to a method of wireless communication performed by a network node. The method may include performing a measurement, in a first set of SRS resources, on an SRS that is associated with a logical channel. The method may include transmitting, in response to the SRS, a grant for transmitting uplink data. The method may include receiving the uplink data, using the logical channel, according to the grant.

Some aspects described herein relate to a UE. The UE may include a processing system. The processing system may include one or more processors and one or more code-storing memories coupled with the one or more processors. The processing system may be configured to cause the UE to transmit, in a first set of SR resources, an SR. The processing system may be configured to cause the UE to transmit, in a first set of SRS resources that is linked to the first set of SR resources, an SRS. The processing system may be configured to cause the UE to receive, in response to transmitting the SRS, a grant for transmitting uplink data.

Some aspects described herein relate to a network node. The network node may include a processing system. The processing system may include one or more processors and one or more code-storing memories coupled with the one or more processors. The processing system may be configured to cause the network node to receive, in a first set of SR resources, an SR. The processing system may be configured to cause the network node to perform a measurement, in a first set of SRS resources that is linked to the first set of SR resources, on an SRS. The processing system may be configured to cause the network node to transmit, in response to the SRS, a grant, based at least in part on the measurement, for transmitting uplink data.

Some aspects described herein relate to a UE. The UE may include a processing system. The processing system may include one or more processors and one or more code-storing memories coupled with the one or more processors. The processing system may be configured to cause the UE to transmit, in a first set of SRS resources, an SRS that is associated with a logical channel. The processing system may be configured to cause the UE to receive, in response to transmitting the SRS, a grant for transmitting uplink data. The processing system may be configured to cause the UE to transmit the uplink data, using the logical channel, according to the grant.

Some aspects described herein relate to a network node. The network node may include a processing system. The processing system may include one or more processors and one or more code-storing memories coupled with the one or more processors. The processing system may be configured to cause the network node to perform a measurement, in a first set of SRS resources, on an SRS that is associated with a logical channel. The processing system may be configured to cause the network node to transmit, in response to the SRS, a grant for transmitting uplink data. The processing system may be configured to cause the network node to receive the uplink data, using the logical channel, according to the grant.

Some aspects described herein relate to a non-transitory computer-readable medium that stores a set of instructions for wireless communication by a UE. The set of instructions, when executed by one or more processors of the UE, may cause the UE to transmit, in a first set of SR resources, an SR. The set of instructions, when executed by one or more processors of the UE, may cause the UE to transmit, in a first set of SRS resources that is linked to the first set of SR resources, an SRS. The set of instructions, when executed by one or more processors of the UE, may cause the UE to receive, in response to transmitting the SRS, a grant for transmitting uplink data.

Some aspects described herein relate to a non-transitory computer-readable medium that stores a set of instructions for wireless communication by a network node. The set of instructions, when executed by one or more processors of the network node, may cause the network node to receive, in a first set of SR resources, an SR. The set of instructions, when executed by one or more processors of the network node, may cause the network node to perform a measurement, in a first set of SRS resources that is linked to the first set of SR resources, on an SRS. The set of instructions, when executed by one or more processors of the network node, may cause the network node to transmit, in response to the SRS, a grant, based at least in part on the measurement, for transmitting uplink data.

Some aspects described herein relate to a non-transitory computer-readable medium that stores a set of instructions for wireless communication by a UE. The set of instructions, when executed by one or more processors of the UE, may cause the UE to transmit, in a first set of SRS resources, an SRS that is associated with a logical channel. The set of instructions, when executed by one or more processors of the UE, may cause the UE to receive, in response to transmitting the SRS, a grant for transmitting uplink data. The set of instructions, when executed by one or more processors of the UE, may cause the UE to transmit the uplink data, using the logical channel, according to the grant.

Some aspects described herein relate to a non-transitory computer-readable medium that stores a set of instructions for wireless communication by a network node. The set of instructions, when executed by one or more processors of the network node, may cause the network node to perform a measurement, in a first set of SRS resources, on an SRS that is associated with a logical channel. The set of instructions, when executed by one or more processors of the network node, may cause the network node to transmit, in response to the SRS, a grant for transmitting uplink data. The set of instructions, when executed by one or more processors of the network node, may cause the network node to receive the uplink data, using the logical channel, according to the grant.

Some aspects described herein relate to an apparatus for wireless communication. The apparatus may include means for transmitting, in a first set of SR resources, an SR. The apparatus may include means for transmitting, in a first set of SRS resources that is linked to the first set of SR resources, an SRS. The apparatus may include means for receiving, in response to transmitting the SRS, a grant for transmitting uplink data.

Some aspects described herein relate to an apparatus for wireless communication. The apparatus may include means for receiving, in a first set of SR resources, an SR. The apparatus may include means for performing a measurement, in a first set of SRS resources that is linked to the first set of SR resources, on an SRS. The apparatus may include means for transmitting, in response to the SRS, a grant, based at least in part on the measurement, for transmitting uplink data.

Some aspects described herein relate to an apparatus for wireless communication. The apparatus may include means for transmitting, in a first set of SRS resources, an SRS that is associated with a logical channel. The apparatus may include means for receiving, in response to transmitting the SRS, a grant for transmitting uplink data. The apparatus may include means for transmitting the uplink data, using the logical channel, according to the grant.

Some aspects described herein relate to an apparatus for wireless communication. The apparatus may include means for performing a measurement, in a first set of SRS resources, on an SRS that is associated with a logical channel. The apparatus may include means for transmitting, in response to the SRS, a grant for transmitting uplink data. The apparatus may include means for receiving the uplink data, using the logical channel, according to the grant.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example associated with using a scheduling request (SR) to trigger a sounding reference signal (SRS).

FIG. 4 is a diagram illustrating an example associated with using an SRS in lieu of an SR.

FIG. 5 is a diagram illustrating an example process performed, for example, by a UE.

FIG. 6 is a diagram illustrating an example process performed, for example, by a network node.

FIG. 7 is a diagram illustrating an example process performed, for example, by a UE.

FIG. 8 is a diagram illustrating an example process performed, for example, by a network node.

FIGS. 9 and 10 are diagrams of example apparatuses for wireless communication.

### DETAILED DESCRIPTION

In a wireless network, a network node may allocate resources (e.g., in time, frequency, and space) for a user equipment (UE) to use to transmit data to the network node. For example, the network node may transmit a grant to the UE indicating the resources allocated for the UE to transmit data. Generally, the network node transmits a grant in response to a scheduling request (SR) from the UE. For example, the UE may transmit the SR based at least in part on having data in a buffer for transmission to the network node.

To improve quality and reliability of transmissions from the UE to the network node, the network node may measure a reference signal from the UE (usually referred to as a “sounding reference signal” or “SRS”) in order to estimate a channel from the UE to the network node. Therefore, the network node may allocate resources for the UE based at least in part on a recent measurement of the reference signal. However, quality and reliability are reduced when the recent measurement was too far in the past.

The network node could configure the UE with periodic or semi-persistent SRS transmissions to ensure that the network node always has a relatively recent measurement available, but such a configuration wastes power and processing resources of the UE. Alternatively, the network node may configure the UE to transmit an aperiodic SRS in response to an SR, but the network node thus increases latency before the UE will be able to transmit data to the network node.

Various aspects relate generally to configuration, and use, of SRS resources that are triggered with an SR. Some aspects more specifically relate to a network node measuring an SRS that was triggered by the SR and providing a grant in response to the SRS. Additionally, or alternatively, various aspects relate generally to configuration, and use, of SRS resources that are associated with a logical channel as an SR on the logical channel. Some aspects more specifically relate to a network node measuring an SRS that functions as the SR and providing a grant in response to the SRS.

Particular aspects of the subject matter described in this disclosure can be implemented to realize one or more of the following potential advantages. In some examples, the described techniques can be used to reduce latency for an uplink transmission from a UE without compromising quality and reliability of the uplink transmission. For example, the grant from the network node may be based at least in part on measurement of the SRS without increased latency incurred by configuring the SRS in response to an SR. Additionally, the described techniques can be used to conserve power and processing resources at the UE that otherwise would have been spent on periodic or semi-persistent SRSs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

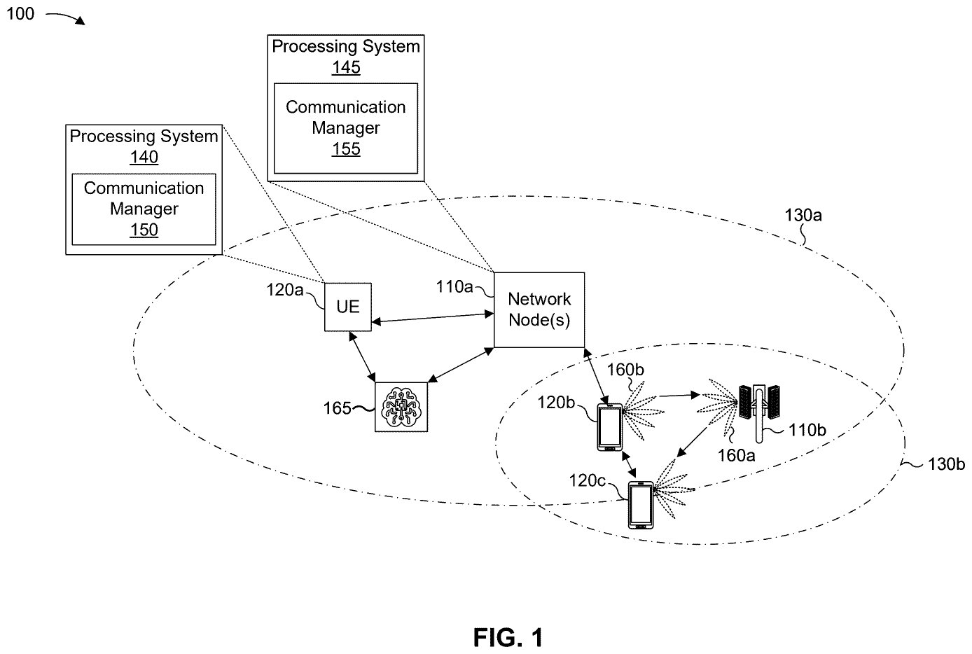

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a processing system 140 with a communication manager 150. As described in more detail elsewhere herein, the communication manager 150 may transmit, in a first set of SR resources, an SR; may transmit, in a first set of SRS resources that is linked to the first set of SR resources, an SRS; and may receive, in response to transmitting the SRS, a grant for transmitting uplink data. Additionally, or alternatively, and as described in more detail elsewhere herein, the communication manager 150 may transmit, in a first set of SRS resources, an SRS that is associated with a logical channel; may receive, in response to transmitting the SRS, a grant for transmitting uplink data; and may transmit the uplink data, using the logical channel, according to the grant. Additionally, or alternatively, the communication manager 150 may perform one or more other operations described herein.

In some aspects, the network node 110 may include a processing system 145 with a communication manager 155. As described in more detail elsewhere herein, the communication manager 155 may receive, in a first set of SR resources, an SR; may perform a measurement, in a first set of SRS resources that is linked to the first set of SR resources, on an SRS; and may transmit, in response to the SRS, a grant, based at least in part on the measurement, for transmitting uplink data. Additionally, or alternatively, and as described in more detail elsewhere herein, the communication manager 155 may perform a measurement, in a first set of SRS resources, on an SRS that is associated with a logical channel; may transmit, in response to the SRS, a grant for transmitting uplink data; and may receive the uplink data, using the logical channel, according to the grant. Additionally, or alternatively, the communication manager 155 may perform one or more other operations described herein.

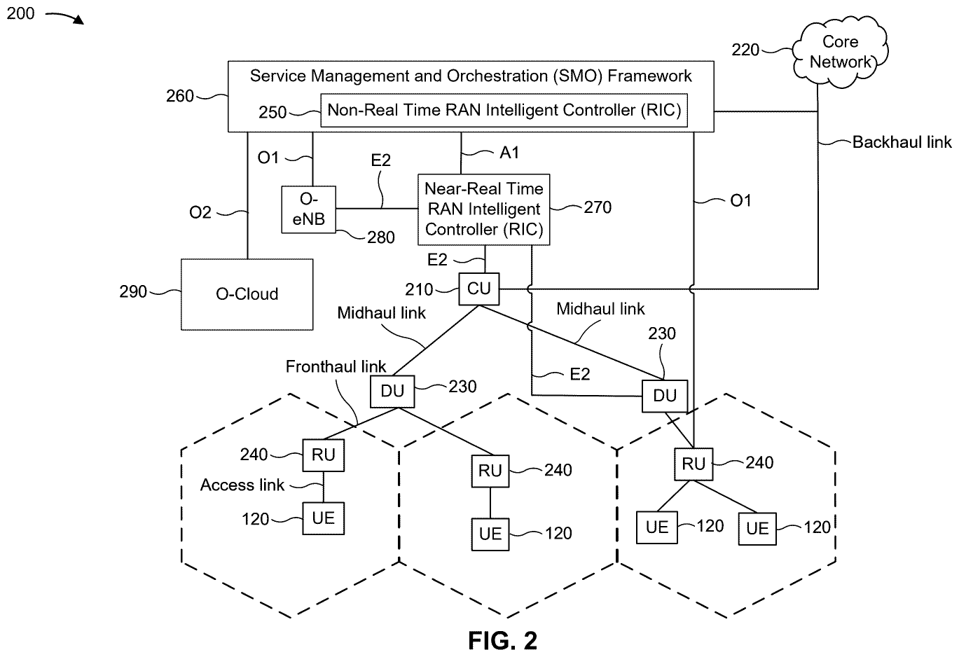

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

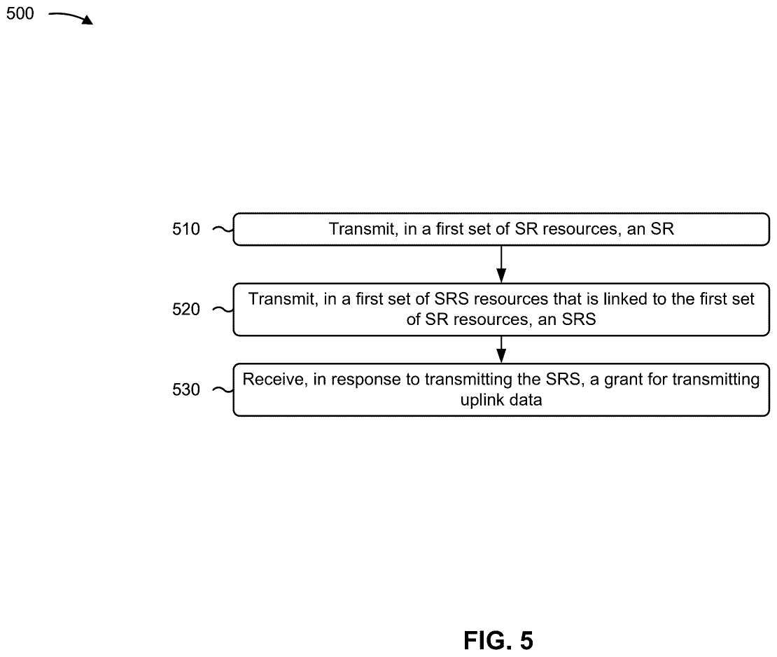

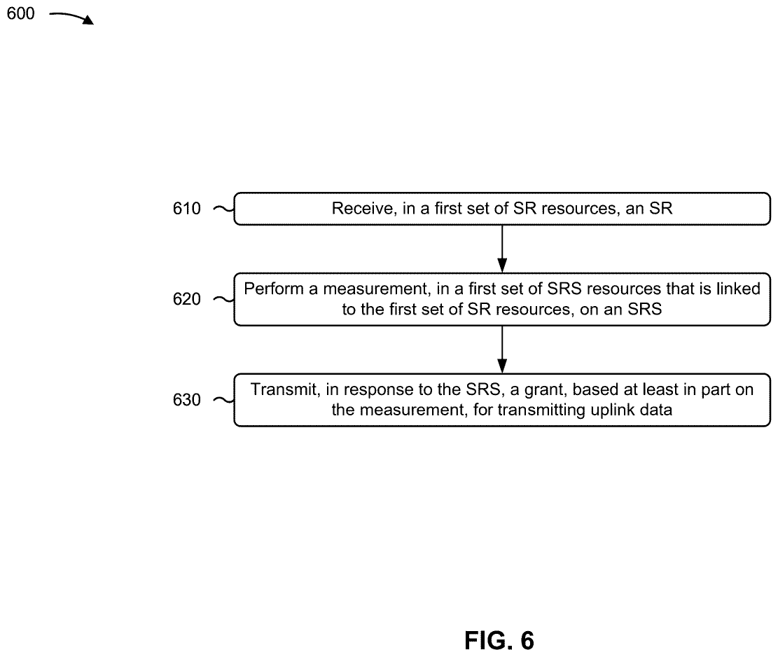

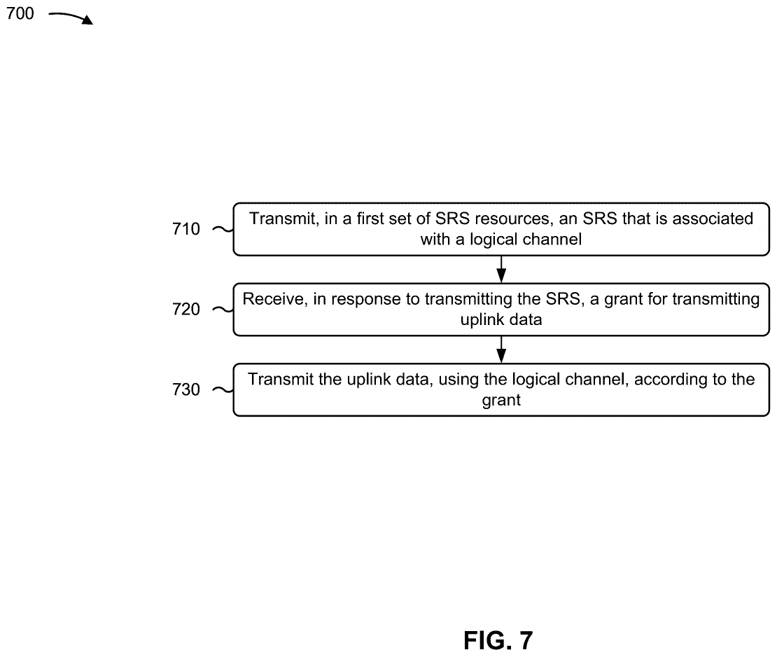

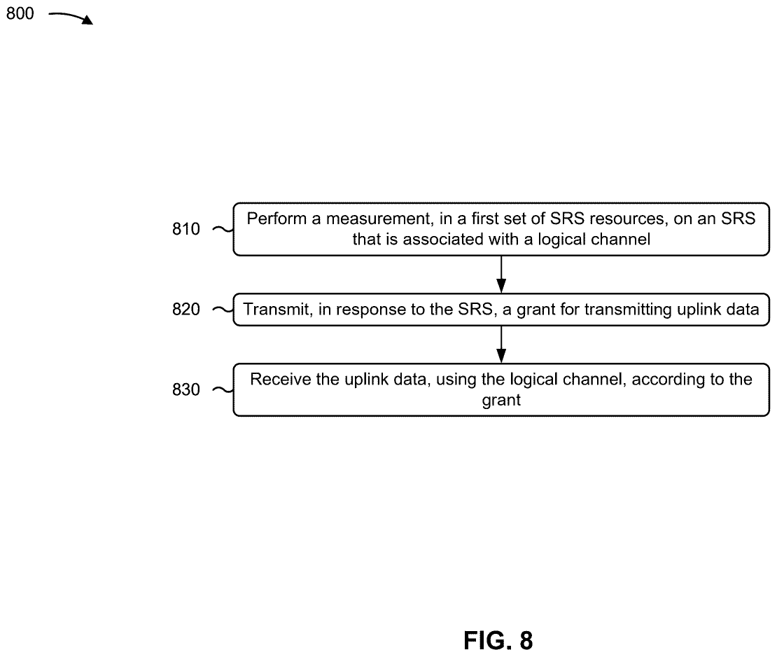

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with triggering SRSs using SRs, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, process 700 of FIG. 7, process 800 of FIG. 8, or other processes as described herein. In some examples, executing instructions may include running the instructions, converting the instructions, compiling the instructions, or interpreting the instructions, among other examples.

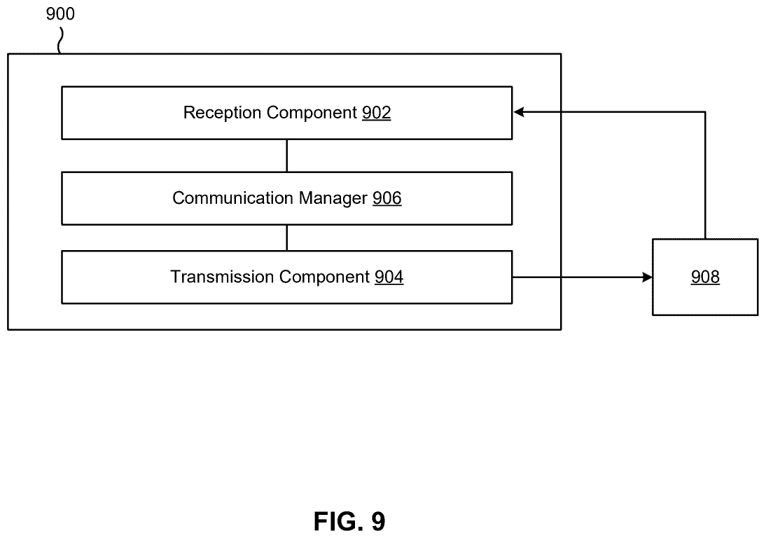

In some aspects, a UE (e.g., the UE 120 or apparatus 900 of FIG. 9) may include means for transmitting, in a first set of SR resources, an SR; means for transmitting, in a first set of SRS resources that is linked to the first set of SR resources, an SRS; and means for receiving, in response to transmitting the SRS, a grant for transmitting uplink data. Additionally, or alternatively, the UE may include means for transmitting, in a first set of SRS resources, an SRS that is associated with a logical channel; means for receiving, in response to transmitting the SRS, a grant for transmitting uplink data; and means for transmitting the uplink data, using the logical channel, according to the grant. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

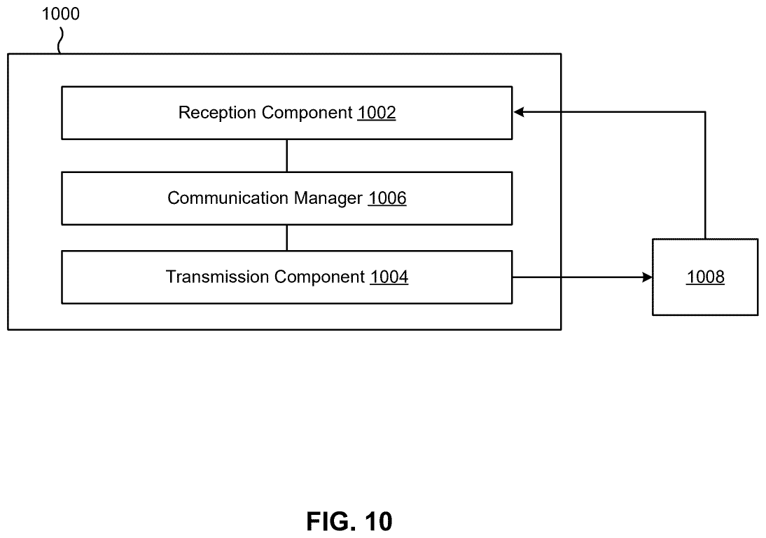

In some aspects, a network node (e.g., the network node 110, the RU 240, the DU 230, the CU 210, or apparatus 1000 of FIG. 10) may include means for receiving, in a first set of SR resources, an SR; means for performing a measurement, in a first set of SRS resources that is linked to the first set of SR resources, on an SRS; and means for transmitting, in response to the SRS, a grant, based at least in part on the measurement, for transmitting uplink data. Additionally, or alternatively, the network node may include means for performing a measurement, in a first set of SRS resources, on an SRS that is associated with a logical channel; means for transmitting, in response to the SRS, a grant for transmitting uplink data; and means for receiving the uplink data, using the logical channel, according to the grant. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

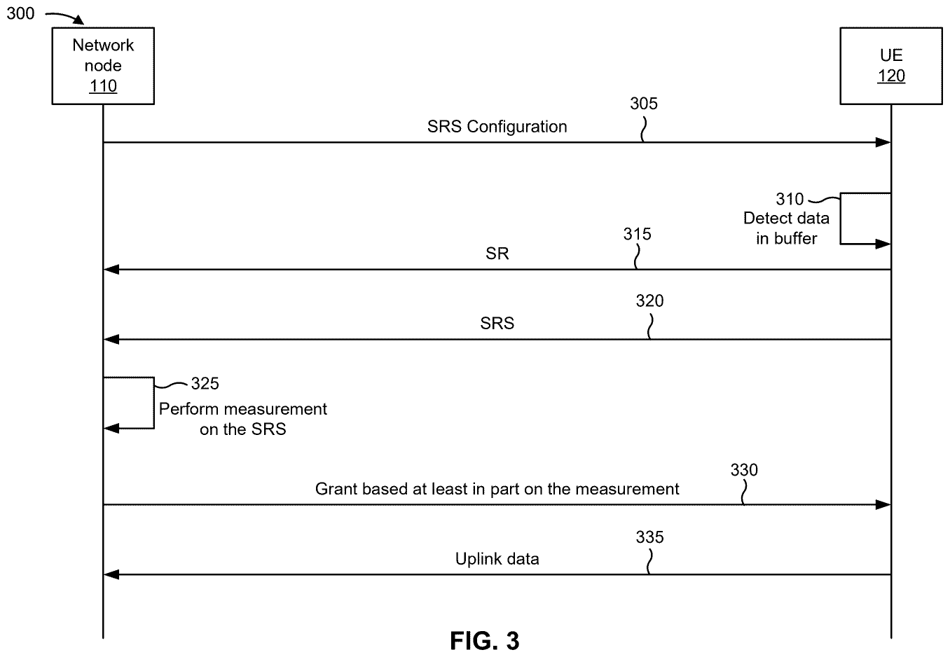

FIG. 3 is a diagram illustrating an example 300 associated with using an SR to trigger an SRS. As shown in FIG. 3, a network node 110 (e.g., an RU 240 or a device controlling the RU 240, such as a DU 230 or a CU 210) and a UE 120 may communicate with one another (e.g., OTA in a wireless network, such as the wireless communication network 100 of FIG. 1).

As shown by reference number 305, the network node 110 may transmit (e.g., directly or via the RU 240), and the UE 120 may receive, a configuration for a set of SRS resources. For example, the configuration may be included in an RRC message (e.g., in an SRS-ResourceSet information element (IE), as defined in 3GPP specifications). The configuration may associate the set of SRS resources with a set of SR resources, such that the set of SRS resources are linked to the set of SR resources. For example, the configuration may include an index (or another type of alphanumeric identifier) associated with a configuration for the set of SR resources. Additionally, or alternatively, the configuration for the set of SR resources may include an index (or another type of alphanumeric identifier) associated with the configuration for the set of SRS resources. Therefore, two sets of resources may be described as “linked” to each other when a configuration for one of the sets of resources indicates (or otherwise references) a configuration for the other of the sets of resources. The configuration for the set of SR resources may be included in a same RRC message or a separate RRC message (e.g., in a SchedulingRequestResourceConfig IE, as defined in 3GPP specifications).

In some aspects, the set of SRS resources may be mapped on a one-to-one basis to the set of SR resources (e.g., to reduce collisions from multiple UEs). Alternatively, the set of SRS resources may be mapped on a many-to-one basis or a many-to-many basis to the set of SR resources, such that other sets of SRS resources are also mapped to the set of SR resources, optionally along with other sets of SR resources (e.g., to reduce memory overhead at the network node 110 and to reduce network congestion). Alternatively, the set of SRS resources may be mapped on a one-to-many basis to the set of SR resources, such that the set of SRS resources is also mapped to other sets of SR resources (e.g., to allow for the same set of SRS resources to be used with multiple logical channels).

To indicate that the set of SR resources may be used to trigger SRS on the set of SRS resources, which in turn may be used to trigger uplink transmissions (e.g., uplink data, a buffer status report (BSR), a delay status report (DSR), a beam failure recovery (BFR) message, or another type of MAC-CE), the set of SRS resources may be associated with a new usage (e.g., in 3GPP specifications or another standard). Alternatively, the set of SRS resources may be associated with a codebook or nonCodebook usage (e.g., defined in 3GPP specifications) but be associated with the set of SR resources.

In some aspects, the network node 110 may configure SR-triggered SRS (using the set of SRS resources) based at least in part on the UE 120 being a customer premises equipment (CPE), a cable modem, or another type of stationary UE. The set of SRS resources may be used when the UE 120 is in a idle mode or an inactive state (rather than the UE 120 performing a random access operation).

As shown by reference number 310, the UE 120 may detect data in a buffer to transmit to the network node 110 (e.g., the UE 120 may determine that the UE 120 has uplink data to transmit). Accordingly, the UE 120 may determine to transmit an SR in the set of SR resources in order to trigger use of the set of SRS resources (that are linked to the set of SR resources). In one example, the UE 120 may determine to transmit the SR based at least in part on the uplink data being associated with a logical channel that is indicated in the configuration for the set of SR resources (or with a triggering MAC-CE that is associated with the set of SR resources). Therefore, the UE 120 may use the set of SR resources to trigger SRSs only for some logical channels or some triggering MAC-CEs. In another example, the UE 120 may determine to transmit the SR based at least in part on a next occasion in the set of SR resources being outside of an active duration for a discontinuous reception (DRX) cycle of the UE 120 or outside of an active duration for a discontinuous transmission (DTX) cycle (or a DRX cycle) of a serving cell including the network node 110. Therefore, the UE 120 may use the set of SR resources outside of the active duration of the DRX cycle of the UE 120 or outside of the active duration of the DTX cycle (or the DRX cycle) of the serving cell. In another example, the UE 120 may determine to transmit the SR based at least in part on a timer (e.g., configured or otherwise indicated by the network node 110) associated with the set of SR resources. Therefore, the UE 120 may use the set of SR resources only once, twice, or another preset number of times while the timer is running. In another example, the UE 120 may determine to transmit the SR based at least in part on lacking an active SRS configuration (e.g., whether periodic, semi-persistent, or aperiodic). Therefore, the UE 120 may use the set of SR resources only when the UE 120 is not already configured to transmit an SRS (e.g., in the near future). In another example, the UE 120 may determine to transmit the SR based at least in part on a channel measurement satisfying a threshold. Therefore, the UE 120 may use the set of SR resources only when the UE 120 determines that a channel between the UE 120 and the network node 110 is likely to have changed (e.g., according to the channel measurement). For example, the channel measurement (e.g., an RSRP or a power delay profile (PDP), among other examples) may have changed (over time) by an amount that satisfies the threshold. In another example, the UE 120 may determine to transmit the SR based at least in part on the serving cell that provided the configuration for the set of SRS resources being the same serving cell to receive the uplink data. Therefore, the UE 120 may use the set of SR resources only in a same cell that configured the set of SR resources. In another example, the UE 120 may determine to transmit the SR based at least in part on an uplink timing at the UE 120 being valid. Therefore, the UE 120 may use the set of SR resources only when an uplink sync timer at the UE 120 is not expired.

Any of the conditions described above may be combined. For example, the conditions may be combined sequentially (e.g., such that the UE 120 determines to transmit the SR based at least in part on the uplink data being associated with the logical channel and based at least in part on a next occasion in the set of SR resources being outside of the active duration for the DRX cycle of the UE 120, among other examples). Alternatively, the conditions may be combined holistically (e.g., by calculating a score, or another indicator, by determining how many conditions are satisfied, such that the UE 120 determines to transmit the SR based at least in part on the score satisfying a holistic threshold).

As shown by reference number 315, the UE 120 may transmit, and the network node 110 may receive (e.g., directly or via the RU 240), the SR in the set of SR resources. The SR may indicate that the UE 120 will transmit an SRS in the set of SRS resources (that is linked to the set of SR resources). For example, a property of the SR (e.g., a cyclic shift or a payload of the SR, among other examples) may indicate that the SRS is triggered. Therefore, the UE 120 may, in other examples, use the set of SR resources with a different property (e.g., a different cyclic shift or a different payload) in order to request an uplink grant without triggering the SRS (that is, without using the set of SRS resources that are linked to the set of SR resources).

Additionally, in some aspects, the SR may indicate a property of the SRS (e.g., which SRS resource in the set of SRS resources is selected). Alternatively, the UE 120 may transmit, and the network node 110 may receive (e.g., directly or via the RU 240), after the SR and before the SRS, an indication of the property of the SRS (e.g., a time or a frequency selected for the SRS, a scrambling or sequence identifier (ID) of the SRS, a cyclic shift of the SRS, or a comb offset of the SRS, among other examples).

In some aspects, the SR may be transmitted using a low-power wake-up transmitter (LP-WUT). Accordingly, the UE 120 may transmit a low-power SR (LP-SR) and begin initializing a main radio (MR) of the UE 120 in response to transmitting the LP-SR.

As shown by reference number 320, the UE 120 may transmit, and the network node 110 may receive (e.g., directly or via the RU 240), the SRS in the set of SRS resources (in response to the SR). If the set of SRS resources includes multiple resources (e.g., each SRS resource is mapped to the set of SR resources), the UE 120 may select an SRS resource from the set of SRS resources randomly or at least pseudo-randomly (e.g., in order to reduce chances of collision with other UEs).

In some aspects, the UE 120 may transmit the SRS in response to absence of (that is, not receiving) a NACK from the network node 110. For example, the network node 110 may transmit a NACK, in response to the SR, in order to prevent (or disallow) the UE 120 from transmitting the SRS (in response to the SR). Therefore, the SR may function as a request to transmit the SRS, and the UE 120 may assume that the request is granted unless the network node 110 transmits the NACK.

The SRS may indicate a property of the uplink data. For example, a property of the SRS (e.g., a scrambling or sequence ID, a cyclic shift, or a comb offset of the SRS, among other examples) may indicate a size of the uplink data, a priority of the uplink data, or another property associated with the uplink data. Additionally, or alternatively, the SRS may indicate (e.g., using a property of the SRS) a portion of a BSR, a DSR, a BFR message, or another type of MAC-CE that triggered the UE 120 to transmit the SR.

In some aspects, the network node 110 and the UE 120 may use carrier aggregation (CA). Accordingly, the UE 120 may transmit the SA in one CC and may transmit the SRS in a different CC.

In some aspects, the SRS may be transmitted using an LP-WUT. Accordingly, the UE 120 may transmit a low-power SRS (LP-SRS) and begin initializing the MR of the UE 120 in response to transmitting the LP-SRS.

In some aspects, the UE 120 may re-transmit the SRS (e.g., periodically in the set of SRS resources). For example, the UE 120 may re-transmit the SRS for an amount of time (e.g., indicated in the configuration for the set of SRS resources) or until a condition is satisfied. Additionally, or alternatively, the UE 120 may re-transmit the SRS until the network node 110 transmits (e.g., directly or via the RU 240) a deactivation signal associated with the set of SRS resources.

As shown by reference number 325, the network node 110 may perform a measurement (e.g., directly or via the RU 240) on the SRS (in the first set of SRS resources). For example, the network node 110 may perform the measurement in response to the SR from the UE 120. The network node 110 may estimate a channel from the UE 120 to (the RU 240 of) the network node 110 using the measurement.

The SRS may be transmitted (by the UE 120) and measured (by the network node 110) using a spatial filter that is quasi-co-located (QCL'd) with the SR. For example, the UE 120, and the network node 110, may use a same TCI state (or QCL'd TCI states) to transmit, and measure, the SRS, respectively.

As shown by reference number 330, the network node 110 may transmit (e.g., directly or via the RU 240), and the UE 120 may receive, a grant for transmitting the uplink data. For example, the grant may be included in DCI. The grant may be based at least in part on the measurement. For example, the network node 110 may determine an MCS or a TCI state to use, among other examples, based at least in part on the channel from the UE 120 to (the RU 240 of) the network node 110. As a result, the network node 110 improves quality and reliability of a transmission including the uplink data.

Alternatively, the UE 120 may transmit, and the network node 110 may receive, the uplink data (in response to the SRS) using configured uplink resources (e.g., on a configured grant (CG) PUSCH). As a result, the network node 110 may conserve power and processing resources by only monitoring the configured uplink resources in response to the SRS (that is, by refraining from monitoring the configured uplink resources otherwise).

As shown by reference number 335, the UE 120 may transmit, and the network node 110 may receive (e.g., directly or via the RU 240), the uplink data according to the grant.

By using techniques as described in connection with FIG. 3, latency for the uplink data is reduced without compromising quality and reliability of the transmission including the uplink data. Additionally, the UE 120 conserves power and processing that otherwise would have been spent on periodic or semi-persistent SRSs.

As indicated above, FIG. 3 is provided as an example. Other examples may differ from what is described with respect to FIG. 3.

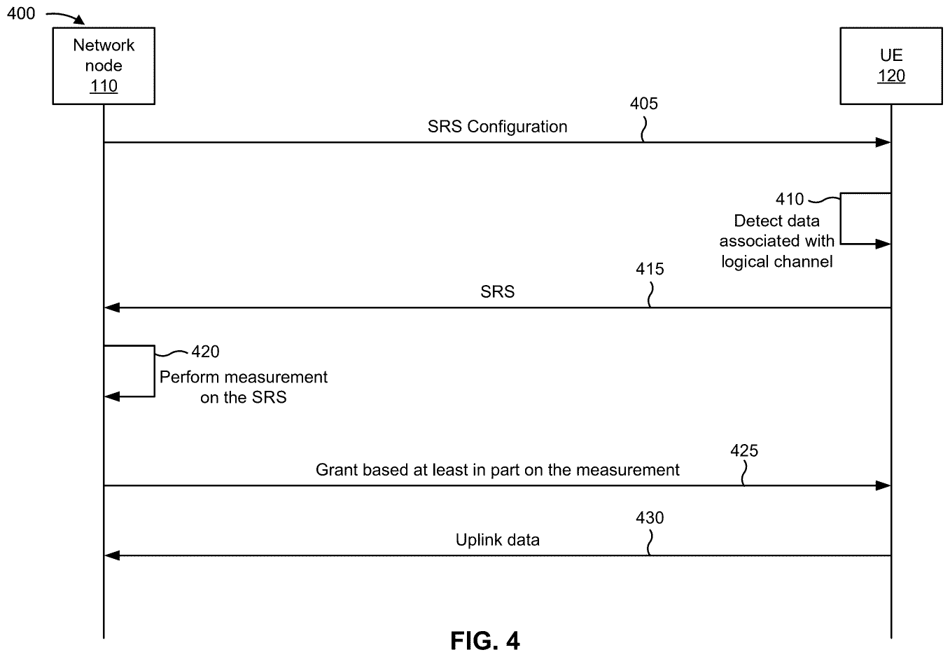

FIG. 4 is a diagram illustrating an example 400 associated with using an SRS in lieu of an SR. As shown in FIG. 4, a network node 110 (e.g., an RU 240 or a device controlling the RU 240, such as a DU 230 or a CU 210) and a UE 120 may communicate with one another (e.g., OTA in a wireless network, such as the wireless communication network 100 of FIG. 1).

As shown by reference number 405, the network node 110 may transmit (e.g., directly or via the RU 240), and the UE 120 may receive, a configuration for a set of SRS resources. For example, the configuration may be included in an RRC message (e.g., in an SRS-ResourceSet IE, as defined in 3GPP specifications). The configuration may associate the set of SRS resources with a logical channel. For example, the configuration may include an index (or another type of alphanumeric identifier) associated with a configuration for the logical channel. The configuration for the logical channel may be included in a same RRC message or a separate RRC message (e.g., in a LogicalChannelConfig IE, as defined in 3GPP specifications). In some aspects, the network node 110 may configure SRS-based SR (with the set of SRS resources) based at least in part on the UE 120 being a CPE, a cable modem, or another type of stationary UE. The set of SRS resources may be used when the UE 120 is in a idle mode or an inactive state (rather than the UE 120 performing a random access operation).

As shown by reference number 410, the UE 120 may detect data, associated with the logical channel, to transmit to the network node 110 (e.g., the UE 120 may determine that the UE 120 has uplink data to transmit using the logical channel). Accordingly, the UE 120 may determine to transmit an SRS in the set of SRS resources in order to request a grant for the uplink data. In one example, the UE 120 may determine to transmit the SRS based at least in part on a next occasion in the set of SRS resources being outside of an active duration for a DRX cycle of the UE 120 or outside of an active duration for a DTX cycle (or a DRX cycle) of a serving cell including the network node 110. Therefore, the UE 120 may use the set of SRS resources outside of the active duration of the DRX cycle of the UE 120 or outside of the active duration of the DTX cycle (or the DRX cycle) of the serving cell. In another example, the UE 120 may determine to transmit the SRS based at least in part on a timer (e.g., configured or otherwise indicated by the network node 110) associated with the set of SRS resources. Therefore, the UE 120 may use the set of SRS resources only once, twice, or another preset number of times while the timer is running. In another example, the UE 120 may determine to transmit the SRS based at least in part on lacking an active SRS configuration (e.g., whether periodic, semi-persistent, or aperiodic). Therefore, the UE 120 may use the set of SRS resources only when the UE 120 is not already configured to transmit an SRS (e.g., in the near future). In another example, the UE 120 may determine to transmit the SRS based at least in part on a channel measurement satisfying a threshold (e.g., the UE 120 measures a strong enough beam associated with a TCI state for the set of SRS resources by determining that an RSRP of an associated SSB or CSI-RS satisfies the threshold). Therefore, the UE 120 may use the set of SRS resources only when the UE 120 determines that a channel between the UE 120 and the network node 110 is likely to have changed (e.g., according to the channel measurement). For example, the channel measurement (e.g., an RSRP or a PDP, among other examples) may have changed (over time) by an amount that satisfies the threshold. In another example, the UE 120 may determine to transmit the SRS based at least in part on a time, since a most recent report or indication associated with the set of SRS resources, satisfying a threshold. Therefore, the UE 120 may use the set of SRS resources only when a time, since transmitting a CSI report or receiving a TCI state indicator associated with the set of SRS resources, is recent enough to satisfy the threshold. In another example, the UE 120 may determine to transmit the SRS based at least in part on the serving cell that provided the configuration for the set of SRS resources being the same serving cell to receive the uplink data. Therefore, the UE 120 may use the set of SRS resources only in a same cell that configured the set of SRS resources. In another example, the UE 120 may determine to transmit the SRS based at least in part on an uplink timing at the UE 120 being valid. Therefore, the UE 120 may use the set of SRS resources only when an uplink sync timer at the UE 120 is not expired.

In some aspects, the UE 120 may determine to transmit the SRS in response to activation of the set of SRS resources. For example, the network node 110 may dynamically activate the set of SRS resources using DCI or a MAC-CE. Conversely, the network node 110 may dynamically deactivate the set of SRS resources using DCI or a MAC-CE.

As shown by reference number 415, the UE 120 may transmit, and the network node 110 may receive (e.g., directly or via the RU 240), the SRS in the set of SRS resources. If the set of SRS resources includes multiple resources (e.g., each SRS resource is mapped to the set of SR resources), the UE 120 may select an SRS resource from the set of SRS resources randomly or at least pseudo-randomly (e.g., in order to reduce chances of collision with other UEs). In some aspects, the UE 120 may transmit the SRS to trigger small data transmission (SDT) (e.g., CG-PUSCH based SDT), at least for a very first transmission.

The SRS may indicate a property of the uplink data. For example, a property of the SRS (e.g., a scrambling or sequence ID, a cyclic shift, or a comb offset of the SRS, among other examples) may indicate a size of the uplink data, a priority of the uplink data, or another property associated with the uplink data.

In some aspects, the SRS may be transmitted using an LP-WUT. Accordingly, the UE 120 may transmit a LP-SRS and begin initializing the MR of the UE 120 in response to transmitting the LP-SRS.

In some aspects, the UE 120 may re-transmit the SRS (e.g., periodically in the set of SRS resources). For example, the UE 120 may re-transmit the SRS for an amount of time (e.g., indicated in the configuration for the set of SRS resources) or until a condition is satisfied. Additionally, or alternatively, the UE 120 may re-transmit the SRS until the network node 110 transmits (e.g., directly or via the RU 240) a deactivation signal associated with the set of SRS resources.

As shown by reference number 420, the network node 110 may perform a measurement (e.g., directly or via the RU 240) on the SRS (in the first set of SRS resources). For example, the network node 110 may perform the measurement in response to the SR from the UE 120. The network node 110 may estimate a channel from the UE 120 to (the RU 240 of) the network node 110 using the measurement.

As shown by reference number 425, the network node 110 may transmit (e.g., directly or via the RU 240), and the UE 120 may receive, a grant for transmitting the uplink data. For example, the grant may be included in DCI. The grant may be based at least in part on the measurement. For example, the network node 110 may determine an MCS or a TCI state to use, among other examples, based at least in part on the channel from the UE 120 to (the RU 240 of) the network node 110. As a result, the network node 110 improves quality and reliability of a transmission including the uplink data.

As shown by reference number 430, the UE 120 may transmit, and the network node 110 may receive (e.g., directly or via the RU 240), the uplink data according to the grant.

The example 300 of FIG. 3 may be combined with the example 400 of FIG. 4. For example, a first set of SRS resources may be linked to a set of SR resources (e.g., to use as described in connection with FIG. 3) while a second set of SRS resources may be associated with a logical channel (e.g., to use as described in connection with FIG. 4).

By using techniques as described in connection with FIG. 4, latency for the uplink data is reduced without compromising quality and reliability of the transmission including the uplink data. Additionally, the UE 120 conserves power and processing that otherwise would have been spent on periodic or semi-persistent SRSs.

As indicated above, FIG. 4 is provided as an example. Other examples may differ from what is described with respect to FIG. 4.

FIG. 5 is a diagram illustrating an example process 500 performed, for example, at a UE or an apparatus of a UE. Example process 500 is an example where the apparatus or the UE (e.g., UE 120) performs operations associated with triggering SRSs using SRs.

As shown in FIG. 5, in some aspects, process 500 may include transmitting, in a first set of SR resources, an SR (block 510). For example, the UE (e.g., using transmission component 904 or communication manager 906, depicted in FIG. 9) may transmit, in a first set of SR resources, an SR, as described herein.

As further shown in FIG. 5, in some aspects, process 500 may include transmitting, in a first set of SRS resources that is linked to the first set of SR resources, an SRS (block 520). For example, the UE (e.g., using transmission component 904 or communication manager 906) may transmit, in a first set of SRS resources that is linked to the first set of SR resources, an SRS, as described herein.

As further shown in FIG. 5, in some aspects, process 500 may include receiving, in response to transmitting the SRS, a grant for transmitting uplink data (block 530). For example, the UE (e.g., using reception component 902 or communication manager 906, depicted in FIG. 9) may receive, in response to transmitting the SRS, a grant for transmitting uplink data, as described herein.

Process 500 may include additional aspects, such as any single aspect or any combination of aspects described below or in connection with one or more other processes described elsewhere herein.

In a first aspect, process 500 includes transmitting (e.g., using transmission component 904 or communication manager 906) the uplink data according to the grant.

In a second aspect, alone or in combination with the first aspect, process 500 includes re-transmitting (e.g., using transmission component 904 or communication manager 906) the SRS for an amount of time associated with the first set of SRS resources.

In a third aspect, alone or in combination with one or more of the first and second aspects, process 500 includes re-transmitting (e.g., using transmission component 904 or communication manager 906) the SRS until a condition, associated with the first set of SRS resources, is satisfied.

In a fourth aspect, alone or in combination with one or more of the first through third aspects, process 500 includes receiving (e.g., using reception component 902 or communication manager 906) a deactivation signal in response to transmitting the SRS, and refraining from re-transmitting (e.g., using transmission component 904 or communication manager 906) the SRS in response to the deactivation signal.

In a fifth aspect, alone or in combination with one or more of the first through fourth aspects, transmitting the SRS includes transmitting the SRS using a spatial filter that is QCL'd with the SR.

In a sixth aspect, alone or in combination with one or more of the first through fifth aspects, transmitting the SRS includes selecting an SRS resource from the first set of SRS resources, and transmitting the SRS in the SRS resource.

In a seventh aspect, alone or in combination with one or more of the first through sixth aspects, the SR is associated with a logical channel, and the logical channel is associated with the first set of SRS resources.

In an eighth aspect, alone or in combination with one or more of the first through seventh aspects, the SR is transmitted outside of an active duration for a DRX cycle of the UE.

In a ninth aspect, alone or in combination with one or more of the first through eighth aspects, the SR is transmitted based at least in part on a channel measurement satisfying a threshold.

In a tenth aspect, alone or in combination with one or more of the first through ninth aspects, a property of the SR indicates that the SRS is triggered.

In an eleventh aspect, alone or in combination with one or more of the first through tenth aspects, the SR is transmitted based at least in part on an uplink timing at the UE being valid.

In a twelfth aspect, alone or in combination with one or more of the first through eleventh aspects, the SR indicates a property of the SRS.

In a thirteenth aspect, alone or in combination with one or more of the first through twelfth aspects, process 500 includes transmitting (e.g., using transmission component 904 or communication manager 906), after the SR and before the SRS, an indication of a property of the SRS, where the property includes a time or a frequency selected for the SRS, a scrambling or sequence ID of the SRS, a cyclic shift of the SRS, or a comb offset of the SRS.

In a fourteenth aspect, alone or in combination with one or more of the first through thirteenth aspects, the SR is transmitted using a first CC, and the SRS is transmitted using a second CC.

In a fifteenth aspect, alone or in combination with one or more of the first through fourteenth aspects, process 500 includes receiving (e.g., using reception component 902 or communication manager 906) a configuration for the first set of SRS resources that associates the first set of SRS resources with the first set of SR resources.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with measuring SRSs that are triggered with SRs.

As shown in FIG. 6, in some aspects, process 600 may include receiving, in a first set of SR resources, an SR (block 610). For example, the network node (e.g., using reception component 1002 or communication manager 1006, depicted in FIG. 10) may receive, in a first set of SR resources, an SR, as described herein.

As further shown in FIG. 6, in some aspects, process 600 may include performing a measurement, in a first set of SRS resources that is linked to the first set of SR resources, on an SRS (block 620). For example, the network node (e.g., using reception component 1002 or communication manager 1006) may perform a measurement, in a first set of SRS resources that is linked to the first set of SR resources, on an SRS, as described herein.

As further shown in FIG. 6, in some aspects, process 600 may include transmitting, in response to the SRS, a grant, based at least in part on the measurement, for transmitting uplink data (block 630). For example, the network node (e.g., using transmission component 1004 or communication manager 1006, depicted in FIG. 10) may transmit, in response to the SRS, a grant, based at least in part on the measurement, for transmitting uplink data, as described herein.

Process 600 may include additional aspects, such as any single aspect or any combination of aspects described below or in connection with one or more other processes described elsewhere herein.

In a first aspect, process 600 includes receiving (e.g., using reception component 1002 or communication manager 1006) the uplink data according to the grant.

In a second aspect, alone or in combination with the first aspect, process 600 includes transmitting (e.g., using transmission component 1004 or communication manager 1006) a deactivation signal in response to performing the measurement.

In a third aspect, alone or in combination with one or more of the first and second aspects, performing the measurement includes performing the measurement on the SRS using a spatial filter that is QCL'd with the SR.

In a fourth aspect, alone or in combination with one or more of the first through third aspects, the first set of SRS resources includes a plurality of SRS resources, and the SRS is measured in a selected SRS resource from the plurality of SRS resources.

In a fifth aspect, alone or in combination with one or more of the first through fourth aspects, the SR is associated with a logical channel, and the logical channel is associated with the first set of SRS resources.

In a sixth aspect, alone or in combination with one or more of the first through fifth aspects, the SR is received outside of an active duration for a DTX cycle of a cell including the network node.

In a seventh aspect, alone or in combination with one or more of the first through sixth aspects, a property of the SR indicates that the SRS is triggered.

In an eighth aspect, alone or in combination with one or more of the first through seventh aspects, the SR indicates a property of the SRS.

In a ninth aspect, alone or in combination with one or more of the first through eighth aspects, process 600 includes receiving (e.g., using reception component 1002 or communication manager 1006), after the SR and before the SRS, an indication of a property of the SRS, where the property includes a time or a frequency selected for the SRS, a scrambling or sequence ID of the SRS, a cyclic shift of the SRS, or a comb offset of the SRS.

In a tenth aspect, alone or in combination with one or more of the first through ninth aspects, the SR is received using a first CC, and the measurement on the SRS is performed using a second CC.

In an eleventh aspect, alone or in combination with one or more of the first through tenth aspects, process 600 includes transmitting (e.g., using transmission component 1004 or communication manager 1006) a configuration for the first set of SRS resources that associates the first set of SRS resources with the first set of SR resources.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE. Example process 700 is an example where the apparatus or the UE (e.g., UE 120) performs operations associated with triggering uplink grants using SRSs instead of SRs.

As shown in FIG. 7, in some aspects, process 700 may include transmitting, in a first set of SRS resources, an SRS that is associated with a logical channel (block 710). For example, the UE (e.g., using transmission component 904 or communication manager 906, depicted in FIG. 9) may transmit, in a first set of SRS resources, an SRS that is associated with a logical channel, as described herein.

As further shown in FIG. 7, in some aspects, process 700 may include receiving, in response to transmitting the SRS, a grant for transmitting uplink data (block 720). For example, the UE (e.g., using reception component 902 or communication manager 906, depicted in FIG. 9) may receive, in response to transmitting the SRS, a grant for transmitting uplink data, as described herein.

As further shown in FIG. 7, in some aspects, process 700 may include transmitting the uplink data, using the logical channel, according to the grant (block 730). For example, the UE (e.g., using transmission component 904 or communication manager 906) may transmit the uplink data, using the logical channel, according to the grant, as described herein.

Process 700 may include additional aspects, such as any single aspect or any combination of aspects described below or in connection with one or more other processes described elsewhere herein.

In a first aspect, the SRS is transmitted in response to a channel measurement satisfying a threshold.

In a second aspect, alone or in combination with the first aspect, the SRS is transmitted outside of an active duration for a DRX cycle of the UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with providing uplink grants in response to SRSs instead of SRs.

As shown in FIG. 8, in some aspects, process 800 may include performing a measurement, in a first set of SRS resources, on an SRS that is associated with a logical channel (block 810). For example, the network node (e.g., using reception component 1002 or communication manager 1006, depicted in FIG. 10) may perform a measurement, in a first set of SRS resources, on an SRS that is associated with a logical channel, as described herein.

As further shown in FIG. 8, in some aspects, process 800 may include transmitting, in response to the SRS, a grant for transmitting uplink data (block 820). For example, the network node (e.g., using transmission component 1004 or communication manager 1006, depicted in FIG. 10) may transmit, in response to the SRS, a grant for transmitting uplink data, as described herein.

As further shown in FIG. 8, in some aspects, process 800 may include receiving the uplink data, using the logical channel, according to the grant (block 830). For example, the network node (e.g., using reception component 1002 or communication manager 1006) may receive the uplink data, using the logical channel, according to the grant, as described herein.

Process 800 may include additional aspects, such as any single aspect or any combination of aspects described below or in connection with one or more other processes described elsewhere herein.

In a first aspect, process 800 includes transmitting (e.g., using transmission component 1004 or communication manager 1006) a deactivation signal associated with the first set of SRS resources, and refraining from monitoring (e.g., using reception component 1002 or communication manager 1006) the first set of SRS resources in response to transmitting the deactivation signal.

In a second aspect, alone or in combination with the first aspect, the measurement on the SRS is performed outside of an active duration for a DTX cycle of a cell including the network node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-4. Additionally, or alternatively, the apparatus 900 may be configured to perform one or more processes described herein, such as process 500 of FIG. 5, process 700 of FIG. 7, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

In some aspects, the transmission component 904 may transmit (e.g., to the apparatus 908) an SR in a first set of SR resources. Additionally, the transmission component 904 may transmit (e.g., to the apparatus 908) an SRS in a first set of SRS resources that is linked to the first set of SR resources. The reception component 902 may receive (e.g., from the apparatus 908) a grant for transmitting uplink data in response to the transmission component 904 transmitting the SRS. Accordingly, the transmission component 904 may transmit (e.g., to the apparatus 908) the uplink data according to the grant.

In some aspects, the transmission component 904 may transmit (e.g., to the apparatus 908) an indication of a property of the SRS, after the SR and before the SRS. In some aspects, the reception component 902 may receive (e.g., from the apparatus 908) a configuration for the first set of SRS resources that associates the first set of SRS resources with the first set of SR resources.

In some aspects, the transmission component 904 may re-transmit the SRS for an amount of time associated with the first set of SRS resources. Additionally, or alternatively, the transmission component 904 may re-transmit the SRS until a condition, associated with the first set of SRS resources, is satisfied. In some aspects, the reception component 902 may receive (e.g., from the apparatus 908) a deactivation signal in response to the transmission component 904 transmitting SRS, such that the transmission component 904 may refrain from re-transmitting the SRS in response to the deactivation signal.

Additionally, or alternatively, the transmission component 904 may transmit (e.g., to the apparatus 908) an SRS in a first set of SRS resources that is associated with a logical channel. The reception component 902 may receive (e.g., from the apparatus) a grant for transmitting uplink data in response to the transmission component 904 transmitting the SRS. The transmission component 904 may transmit (e.g., to the apparatus 908) the uplink data, using the logical channel, according to the grant. In some aspects, the reception component 902 may receive (e.g., from the apparatus 908) a configuration for the first set of SRS resources that associates the first set of SRS resources with the logical channel.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3-4. Additionally, or alternatively, the apparatus 1000 may be configured to perform one or more processes described herein, such as process 600 of FIG. 6, process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

In some aspects, the reception component 1002 may receive (e.g., from the apparatus 1008) an SR in a first set of SR resources. Additionally, the reception component 1002 may perform a measurement, in a first set of SRS resources that is linked to the first set of SR resources, on an SRS. The transmission component 1004 may transmit (e.g., to the apparatus 1008) a grant, in response to the SRS and based at least in part on the measurement, for transmitting uplink data. Accordingly, the reception component 1002 may receive (e.g., from the apparatus 1008) the uplink data according to the grant.

In some aspects, the reception component 1002 may receive (e.g., from the apparatus 1008) an indication of a property of the SRS, after the SR and before the SRS. In some aspects, the transmission component 1004 may transmit (e.g., to the apparatus 1008) a configuration for the first set of SRS resources that associates the first set of SRS resources with the first set of SR resources.

In some aspects, the transmission component 1004 may transmit (e.g., to the apparatus 1008) a deactivation signal in response to reception component 1002 performing the measurement.

Additionally, or alternatively, the reception component 1002 may perform a measurement, in a first set of SRS resources, on an SRS that is associated with a logical channel. The transmission component 1004 may transmit (e.g., to the apparatus 1008) a grant for transmitting uplink data in response to the SRS. The reception component 1002 may receive (e.g., from the apparatus 1008) the uplink data, using the logical channel, according to the grant.

In some aspects, the transmission component 1004 may transmit (e.g., to the apparatus 1008) a configuration for the first set of SRS resources that associates the first set of SRS resources with the logical channel. In some aspects, the transmission component 1004 may transmit (e.g., to the apparatus 1008) a deactivation signal associated with the first set of SRS resources, and the reception component 1002 may refrain from monitoring the first set of SRS resources in response to the transmission component 1004 transmitting the deactivation signal.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, in a first set of scheduling request (SR) resources, an SR; transmitting, in a first set of sounding reference signal (SRS) resources that is linked to the first set of SR resources, an SRS; and receiving, in response to transmitting the SRS, a grant for transmitting uplink data.

Aspect 2: The method of Aspect 1, further comprising: transmitting the uplink data according to the grant.

Aspect 3: The method of any of Aspects 1-2, further comprising: re-transmitting the SRS for an amount of time associated with the first set of SRS resources.

Aspect 4: The method of any of Aspects 1-3, further comprising: re-transmitting the SRS until a condition, associated with the first set of SRS resources, is satisfied.

Aspect 5: The method of any of Aspects 1-4, further comprising: receiving a deactivation signal in response to transmitting the SRS; and refraining from re-transmitting the SRS in response to the deactivation signal.

Aspect 6: The method of any of Aspects 1-5, wherein transmitting the SRS comprises: transmitting the SRS using a spatial filter that is quasi-co-located with the SR.

Aspect 7: The method of any of Aspects 1-6, wherein transmitting the SRS comprises: selecting an SRS resource from the first set of SRS resources; and transmitting the SRS in the SRS resource.

Aspect 8: The method of any of Aspects 1-7, wherein the SR is associated with a logical channel, and the logical channel is associated with the first set of SRS resources.

Aspect 9: The method of any of Aspects 1-8, wherein the SR is transmitted outside of an active duration for a discontinuous reception cycle of the UE.

Aspect 10: The method of any of Aspects 1-9, wherein the SR is transmitted based at least in part on a channel measurement satisfying a threshold.

Aspect 11: The method of any of Aspects 1-10, wherein a property of the SR indicates that the SRS is triggered.

Aspect 12: The method of any of Aspects 1-11, wherein the SR is transmitted based at least in part on an uplink timing at the UE being valid.

Aspect 13: The method of any of Aspects 1-12, wherein the SR indicates a property of the SRS.

Aspect 14: The method of any of Aspects 1-13, further comprising: transmitting, after the SR and before the SRS, an indication of a property of the SRS, wherein the property includes a time or a frequency selected for the SRS, a scrambling or sequence identifier of the SRS, a cyclic shift of the SRS, or a comb offset of the SRS.

Aspect 15: The method of any of Aspects 1-14, wherein the SR is transmitted using a first component carrier (CC), and the SRS is transmitted using a second CC.

Aspect 16: The method of any of Aspects 1-15, further comprising: receiving a configuration for the first set of SRS resources that associates the first set of SRS resources with the first set of SR resources.

Aspect 17: A method of wireless communication performed by a network node, comprising: receiving, in a first set of scheduling request (SR) resources, an SR; performing a measurement, in a first set of sounding reference signal (SRS) resources that is linked to the first set of SR resources, on an SRS; and transmitting, in response to the SRS, a grant, based at least in part on the measurement, for transmitting uplink data.

Aspect 18: The method of Aspect 17, further comprising: receiving the uplink data according to the grant.

Aspect 19: The method of any of Aspects 17-18, further comprising: transmitting a deactivation signal in response to performing the measurement.

Aspect 20: The method of any of Aspects 17-19, wherein performing the measurement comprises: performing the measurement on the SRS using a spatial filter that is quasi-co-located with the SR.

Aspect 21: The method of any of Aspects 17-20, wherein the first set of SRS resources comprises a plurality of SRS resources, and the SRS is measured in a selected SRS resource from the plurality of SRS resources.

Aspect 22: The method of any of Aspects 17-21, wherein the SR is associated with a logical channel, and the logical channel is associated with the first set of SRS resources.

Aspect 23: The method of any of Aspects 17-22, wherein the SR is received outside of an active duration for a discontinuous transmission cycle of a cell including the network node.

Aspect 24: The method of any of Aspects 17-23, wherein a property of the SR indicates that the SRS is triggered.

Aspect 25: The method of any of Aspects 17-24, wherein the SR indicates a property of the SRS.

Aspect 26: The method of any of Aspects 17-25, further comprising: receiving, after the SR and before the SRS, an indication of a property of the SRS, wherein the property includes a time or a frequency selected for the SRS, a scrambling or sequence identifier of the SRS, a cyclic shift of the SRS, or a comb offset of the SRS.

Aspect 27: The method of any of Aspects 17-26, wherein the SR is received using a first component carrier (CC), and the measurement on the SRS is performed using a second CC.

Aspect 28: The method of any of Aspects 17-27, further comprising: transmitting a configuration for the first set of SRS resources that associates the first set of SRS resources with the first set of SR resources.

Aspect 29: A method of wireless communication performed by a user equipment (UE), comprising: transmitting, in a first set of sounding reference signal (SRS) resources, an SRS that is associated with a logical channel; receiving, in response to transmitting the SRS, a grant for transmitting uplink data; and transmitting the uplink data, using the logical channel, according to the grant.

Aspect 30: The method of Aspect 29, wherein the SRS is transmitted in response to a channel measurement satisfying a threshold.

Aspect 31: The method of any of Aspects 29-30, wherein the SRS is transmitted outside of an active duration for a discontinuous reception cycle of the UE.

Aspect 32: A method of wireless communication performed by a network node, comprising: performing a measurement, in a first set of sounding reference signal (SRS) resources, on an SRS that is associated with a logical channel; transmitting, in response to the SRS, a grant for transmitting uplink data; and receiving the uplink data, using the logical channel, according to the grant.

Aspect 33: The method of Aspect 32, further comprising: transmitting a deactivation signal associated with the first set of SRS resources; and refraining from monitoring the first set of SRS resources in response to transmitting the deactivation signal.

Aspect 34: The method of any of Aspects 32-33, wherein the measurement on the SRS is performed outside of an active duration for a discontinuous transmission cycle of a cell including the network node.

Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34.

Aspect 36: An apparatus for wireless communication at a device, the apparatus comprising one or more memories and one or more processors coupled to the one or more memories, the one or more processors configured to cause the device to perform the method of one or more of Aspects 1-34.

Aspect 37: An apparatus for wireless communication, the apparatus comprising at least one means for performing the method of one or more of Aspects 1-34.

Aspect 38: A non-transitory computer-readable medium storing code for wireless communication, the code comprising instructions executable by one or more processors to perform the method of one or more of Aspects 1-34.

Aspect 39: A non-transitory computer-readable medium storing a set of instructions for wireless communication, the set of instructions comprising one or more instructions that, when executed by one or more processors of a device, cause the device to perform the method of one or more of Aspects 1-34.

Aspect 40: A device for wireless communication, the device comprising a processing system that includes one or more processors and one or more memories coupled with the one or more processors, the processing system configured to cause the device to perform the method of one or more of Aspects 1-34.

Aspect 41: An apparatus for wireless communication at a device, the apparatus comprising one or more memories and one or more processors coupled to the one or more memories, the one or more processors individually or collectively configured to cause the device to perform the method of one or more of Aspects 1-34.

Aspect 42: A device comprising a processing system that includes one or more processors and one or more code-storing memories coupled with the one or more processors, the processing system configured to cause the device to perform the method of one or more of Aspects 1-34.

Aspect 43: A device comprising a processing system that includes processor circuitry and code-storing memory circuitry, the processing system configured to cause the device to perform the method of one or more of Aspects 1-34.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code storing memories coupled with the one or more processors, the processing system configured to cause the UE to:
transmit, in a first set of scheduling request (SR) resources, an SR;
transmit, in a first set of sounding reference signal (SRS) resources that is linked to the first set of SR resources, an SRS; and
receive, in response to transmitting the SRS, a grant for transmitting uplink data.

2. The UE of claim 1, wherein the processing system is configured to cause the UE to:
transmit the uplink data according to the grant.

3. The UE of claim 1, wherein the processing system is configured to cause the UE to:
re-transmit the SRS for an amount of time associated with the first set of SRS resources or until a condition, associated with the first set of SRS resources, is satisfied.

4. The UE of claim 1, wherein the processing system is configured to cause the UE to:
receive a deactivation signal in response to transmitting the SRS; and
refrain from re-transmitting the SRS in response to the deactivation signal.

5. The UE of claim 1, wherein, to transmit the SRS, the processing system is configured to cause the UE to:
transmit the SRS using a spatial filter that is quasi-co-located with the SR.

6. The UE of claim 1, wherein, to transmit the SRS, the processing system is configured to cause the UE to:
select an SRS resource from the first set of SRS resources; and
transmit the SRS in the SRS resource.

7. The UE of claim 1, wherein the SR is associated with a logical channel, and the logical channel is associated with the first set of SRS resources.

8. The UE of claim 1, wherein the SR is transmitted outside of an active duration for a discontinuous reception cycle of the UE.

9. The UE of claim 1, wherein the SR is transmitted based at least in part on a channel measurement satisfying a threshold.

10. The UE of claim 1, wherein a property of the SR indicates that the SRS is triggered.

11. The UE of claim 1, wherein the SR is transmitted based at least in part on an uplink timing at the UE being valid.

12. The UE of claim 1, wherein the SR indicates a property of the SRS.

13. The UE of claim 1, wherein the processing system is configured to cause the UE to:
transmit, after the SR and before the SRS, an indication of a property of the SRS,
wherein the property includes a time or a frequency selected for the SRS, a scrambling or sequence identifier of the SRS, a cyclic shift of the SRS, or a comb offset of the SRS.

14. The UE of claim 1, wherein the SR is transmitted using a first component carrier (CC), and the SRS is transmitted using a second CC.

15. The UE of claim 1, wherein the processing system is configured to cause the UE to:
receive a configuration for the first set of SRS resources that associates the first set of SRS resources with the first set of SR resources.

16. A user equipment (UE), comprising:
a processing system that includes one or more processors and one or more code storing memories coupled with the one or more processors, the processing system configured to cause the UE to:
transmit, in a first set of sounding reference signal (SRS) resources, an SRS that is associated with a logical channel;
receive, in response to transmitting the SRS, a grant for transmitting uplink data; and
transmit the uplink data, using the logical channel, according to the grant.

17. The UE of claim 16, wherein the SRS is transmitted in response to a channel measurement satisfying a threshold.

18. The UE of claim 16, wherein the SRS is transmitted outside of an active duration for a discontinuous reception cycle of the UE.

19. A method of wireless communication performed by a user equipment (UE), comprising:
transmitting, in a first set of scheduling request (SR) resources, an SR;
transmitting, in a first set of sounding reference signal (SRS) resources that is linked to the first set of SR resources, an SRS; and
receiving, in response to transmitting the SRS, a grant for transmitting uplink data.

20. The method of claim 19, further comprising:
transmitting the uplink data according to the grant.
